(19) United States
(12) Patent Application Publication
(10) Pub. No.: US 2024/0205761 A1
(43) Pub. Date: Jun. 20, 2024

(54) USER EQUIPMENT MOBILITY BASED ON NETWORK SLICE CONSIDERATIONS

(71) Applicant: Apple Inc., Cupertino, CA (US)

(72) Inventors: Vijay Venkataraman, San Jose, CA (US); Alosious Pradeep Prabhakar, Singapore (SG); Rohit R. Matolia, Bangalore (IN)

(21) Appl. No.: 18/083,334

(22) Filed: Dec. 16, 2022

(51) Int. Cl. H04W 36/00

(52) U.S. Cl. CPC H04W 36/0061; H04W 36/0058; H04W 36/0079

(57) ABSTRACT

Methods and apparatuses for a user equipment (UE) to perform reselection using slice information. In some embodiments, the UE comprises one or more processors configured to perform operations comprising: accessing UE-specific slice information while in the idle or inactive state; and performing cell reselection based on the UE slice information associated with individual slices.

### FIELD OF INVENTION

Embodiments disclosed herein relate generally to wireless technology and more particularly to user equipment (US) reselection based on network slice information.

### BACKGROUND

Fifth generation mobile network (5G) is a wireless standard that aims to improve upon data transmission speed, reliability, availability, and more. This standard, while still developing, includes numerous details relating to various aspects of wireless communication, for example, NR and NR in a spectrum greater than 52.6 GHz.

### SUMMARY OF THE DESCRIPTION

Methods and apparatuses for a user equipment (UE) to perform reselection using slice information. In some embodiments, the UE comprises one or more processors configured to perform operations comprising: accessing UE-specific slice information while in the idle or inactive state; and performing cell reselection based on the UE slice information associated with individual slices.

In some other embodiments, the UE comprises one or more processors configured to perform operations comprising: observing occurrence of at least one of a radio link failure (RLF), a Radio Resource Control (RRC) reconfiguration failure, and a handover (HO) failure while the UE is subscribed to a slice in a current cell and using services of the slice; and performing cell selection based on slice priority information related to use by the UE of the services of the slice.

In some other embodiments, the UE comprises one or more processors configured to perform operations comprising: receiving network slice access group (NSAG) information; entering idle mode while camping on a Long Term Evolution (LTE) cell that does or does not supports at least one slice in 5G New Radio (NR); and performing reselection from LTE to 5G NR of one or more of a cell, RNA, TA or RA based on the NSAG information and UE-specific slice priority information regarding the one or more of a cell, RNA, TA or RA.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to some embodiments.

FIG. 2 illustrates a base station (BS) in communication with a user equipment (UE) device according to some embodiments.

FIG. 3 illustrates an example block diagram of a UE according to some embodiments.

FIG. 4 illustrates an example block diagram of a BS according to some embodiments.

FIG. 5 illustrates an example block diagram of cellular communication circuitry, according to some embodiments.

FIG. 6 illustrates an example of data flow for a UE reselection process that uses stored slice specific information and network provided information.

FIG. 7 illustrates an example of UE reselection and reestablishment after RLF based on slice information.

FIG. 8 illustrates an example of performing the reselection of 5G based on the NSAG

FIG. 9 illustrates a data flow diagram of one embodiment for process for performing UE reselection based on slice information

FIG. 10 is a data flow diagram of some embodiments of a process for performing radio link failure recovery based on slice priority information.

FIG. 11 is a data flow diagram of one embodiment of a process for performing RAT reselection.

### DETAILED DESCRIPTION

A method and apparatus of a device that performs reselection (e.g., cell reselection) based on slice information. The reselection can be based on stored information on individual slices and network provided information, slice priority information with or without slice group information (in response to a radio link failure, RRC Reconfiguration failure, or a handover failure), and 5G NR reselection based on stored group information.

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that performs resource allocation for a multi-panel simultaneous transmission of multiple Physical Uplink Shared Channels (PUSCHs) using a single downlink control information (DCI) is described. In one embodiment, the device is a user equipment device that has a wireless link with a base station. In one embodiment, the wireless link is a fifth generation (5G) link.

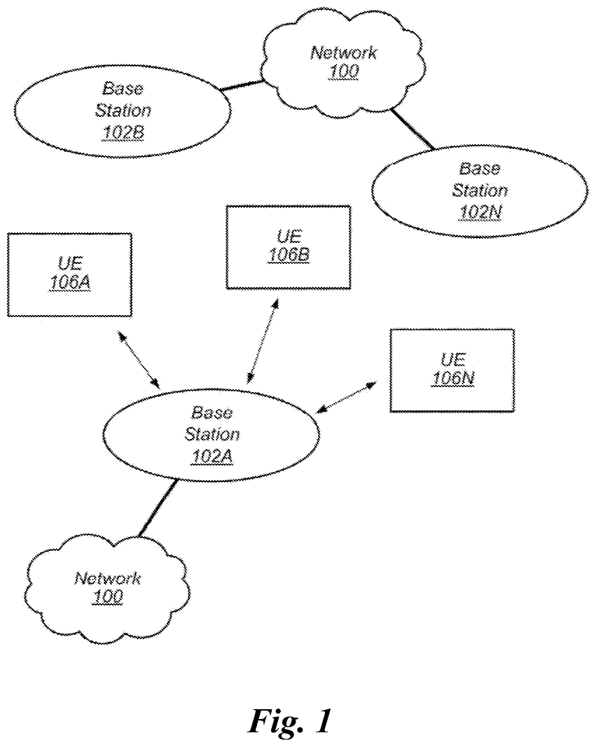

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (ULE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHIRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

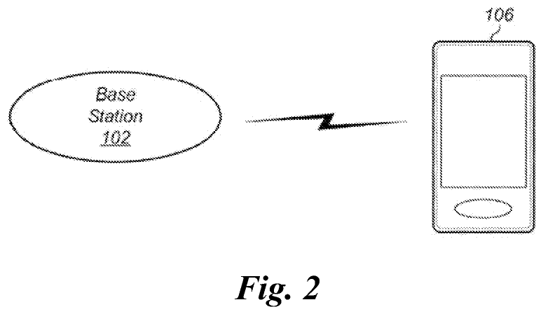

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/RPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

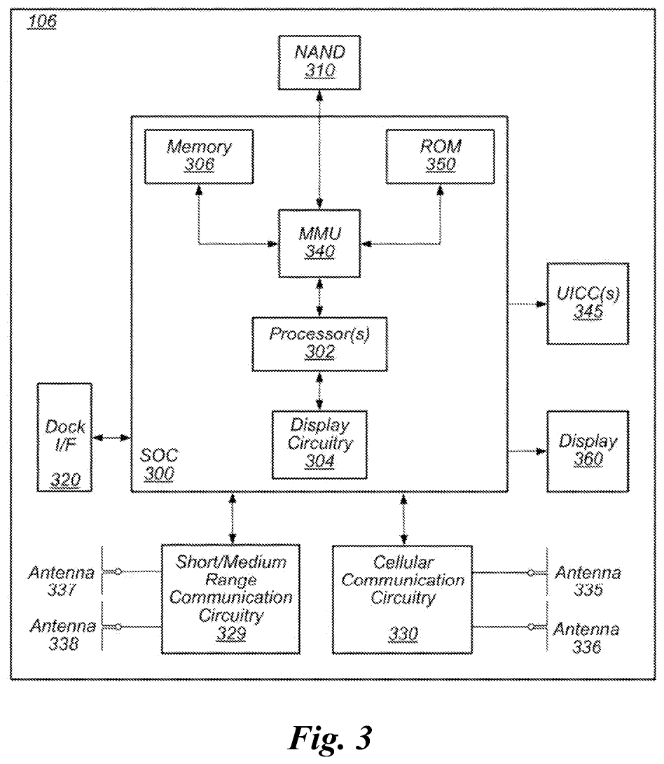

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to perform reselection (e.g., cell reselection) based on slice information, reselection based on stored information on individual slices and network provided information, slice priority information with or without slice group information (in response to a radio link failure, RRC Reconfiguration failure, or a handover failure), and 5G NR selection based on stored group information.

As described herein, the communication device 106 may include hardware and software components for implementing the above features for time division multiplexing UL data for NSA NR operations. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short-range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short-range wireless communication circuitry 329 may include one or more ICs that are configured to perform the functions of short-range wireless communication circuitry 32. In addition, each integrated circuit may include circuitry (e.g., first circuitry, second circuitry, etc.) configured to perform the functions of short-range wireless communication circuitry 329.

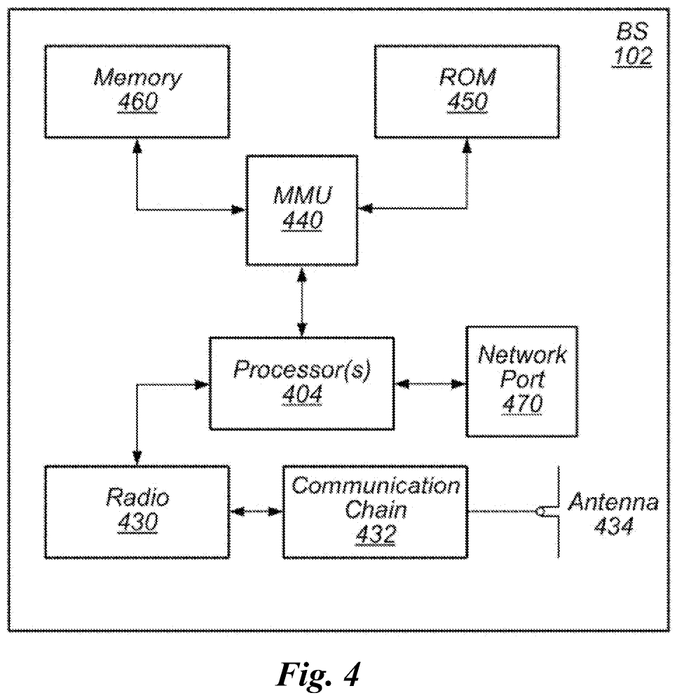

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

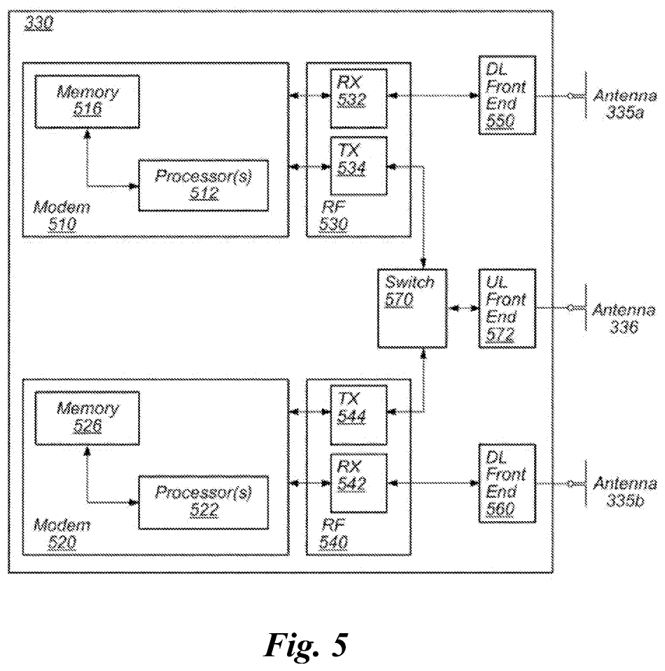

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be include in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively, directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for performing reselection (e.g., cell reselection) based on slice information, reselection based on stored information on individual slices and network provided information, slice priority information with or without slice group information (in response to an radio link failure, RRC Reconfiguration failure, or a handover failure), and 5G NR reselection based on stored group information, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for performing reselection (e.g., cell reselection) based on slice information, reselection based on stored information on individual slices and network provided information, slice priority information with or without slice group information (in response to an radio link failure, RRC Reconfiguration failure, or a handover failure), and 5G NR reselection based on stored group information, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

### UE Mobility Based on Network Slice Considerations

As part of the 5G Standard, the network (e.g., base station) can provide a UE with slice groups and ask the UE to perform cell reselection based on the priority of the slice group and their support in target cells. In such cases, the System Information Block (SIB) of a target cell is broadcasted with group priority support information.

However, there are a number of limitations with this current approach. These limitations include, but are not limited to, that the UE priority of a particular Single-Network Slice Selection Assistance Information (S-NSSAI), which uniquely identifies a network slice, might be different than the priority of the group of which the slice is a part. For example, as given below in Table 1, group 1 has slices a, b, and c and group 1 has priority 1. Group 2 has slices b, x and y and group 2 has priority 2. Group 3 has slices c, y and z and group 3 has priority 3. Thus, the network provides the groups and the priority of the groups (but not the priority of the individual slices). However, a UE may have a priority for one of these slices in Groups 1-3 that is different than the Priority 1-3, respectively. Furthermore, the network won't provide an indication of a slice that should be prioritized during cell reselection. In other words, the 5G Standard does not provide for reselection based on the priority of individual slices.

TABLE 1

| | | | | |
|---|---|---|---|---|
| Group 1 | S-NSSAIa | S-NSSAIb | S-NSSAIc | Priority 1 |
| Group 2 | S-NSSAIb | S-NSSAIx | S-NSSAIy | Priority 2 |
| Group 3 | S-NSSAIc | S-NSSAIy | S-NSSAIz | Priority 3 |

Another limitation is that there are no complete provisions of radio link failure (RLF) recovery to cells supporting active slices; the only provisions for RLF recovery is group information and the group priority. Furthermore, there is no threshold defined for the reselection of cells, and priority based on slice support controls over any preference regarding a cell's signal quality. In other words, the network indicates the slice group that must be prioritized which controls cell reselection even though the signal level for the target cell may not be at the quality with another currently available cell.

### UE Re-Selection Influenced by Network Slicing

In some embodiments, the UE performs reselection based on individual slice information. In some embodiments, the UE performs cell reselection based on slice information it has and information provided by the network. The slice information can include priority information for each individual slice as opposed to a slice group priority.

In some embodiments, when the UE is to exit the idle or inactive mode, the UE performs reselection by prioritizing the cell, RAN Notification Area (RNA), Registration Area (RA), or Tracking Area (TA) based on information indicative of one or more individual slices, such as, for example, a slice that is being used the most by the UE. In some embodiments, the UE tracks slice usage information, stores the slice usage information in a memory of the UE (or accessible by the UE), and feeds that slice usage information into reselection logic (e.g., a processor or other processing device of the UE) to make the reselection decision. The slice usage information can be for a specific period of time (e.g., usage during the past day, usage during the past week, etc.) and/or UE location.

In some embodiments, the UE performs reselection based on user application usage preferences configured by user in the user interface (UI). For example, if the Apple TV application is being used in the UI of the UE, then the slice in which the Apple TV application is being run becomes the slice with the highest priority (e.g., the priority 1 slice). These preferences can be configured by the user. In some embodiment, UE performs reselection based on information collected or dynamically learned by the operating system (e.g., iOS) with respect to commonly used slices over a predetermined period of time (e.g., over a 14 day period, etc.). The collected information can be stored in a memory of the UE and accessed when performing cell reselection.

In some embodiments, the UE performs reselection based by prioritizing the slice that was being used when the UE went into an Idle or Inactive state. For example, if the UE went into the Idle or Inactive state when watching a show on Apple TV, then in some embodiments, the UE performs reselection based on that active slice (prioritizing that active slice over another slice that may have a reselection priority at the time of reselection.

In some embodiments, the UE performs reselection based on both the user application usage preferences and on the slice being used when the UE went into an Idle or Inactive state.

In some other embodiment, the UE can be configured to also limit idle mode camping in RNA/RA/TA belonging in order to support maximum slices subscribed by the UE. For example, in some embodiments, the UE performs reselection using information that include a combination of Registration accept, Policy, slice access group information and UE collected information on individual slices (e.g., usage information and usage patterns). That is, the UE is configured with a subscription during registration that includes information regarding slice information (e.g., slices that the UE may need or want to use) and access group information, as well as policy information, and uses this information with the UE collected information on individual slices to select a cell during cell reselection.

In some embodiments, if a user launches an application with another slice priority in Idle mode, the UE is configured to prefer reselection to a cell that supports that new slice. In other words, UE's cell reselection uses that slice information as part of determining which cell to select during cell reselection. In some embodiments, while taking into account that the user had launched an application with another slice while in idle mode, the cell reselection can also take into account that of any Registration request that is initiated for a different slice where the UE is configured to prefer a cell supporting the respective slice when the user initiates an application while in the Idle/Inactive mode. For example, if a user is using Apple TV in one slice and goes into another application, such as a medical consultation application in another slice, then that new slice is preferred during reselection with a slightly higher priority based on the fact that the user selected to use that new slice.

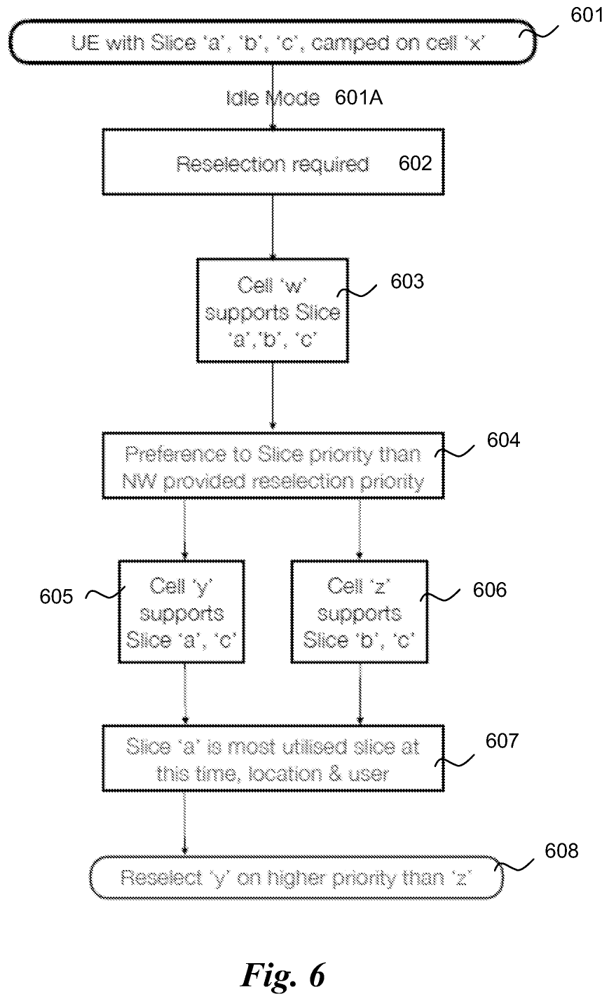

FIG. 6 illustrates an example of data flow for a UE reselection process that uses stored slice specific information and network provided information. Referring to FIG. 6, in this example, the UE has subscription to slice a, b, c, is camped on cell x (601) and is in Idle or Inactive mode (601A). In some embodiments, when leaving the Idle or Inactive mode, reselection by the UE is required (602). In some embodiments, reselection is required as network conditions, defined reselection priorities or current cell coverage.

At this point, cell w is available with slices a, b, c, but the cell has a lower priority than other cells (603). In some embodiments, the UE performs reselection to cell w if the signal quality of cell w being greater than a signal quality threshold for cell w and the signal quality of other cells is less than the signal quality threshold associated with cell x.

In some embodiments, if there are two cells available such as, for example, cell y (605), which supports slices a and c, and cell z (606), which supports slices b and c, then the UE performs reselection by checking which slice is mostly utilized (utilized most often) by user at this point of time at the UE's current locations as per stored information (e.g., tracked information stored in the UE's memory). In some embodiment, the UE's reselection process in this case also takes into account whether a slice (e.g., slice a) was active before the UE went to Idle or Inactive state (607). To that end, the UE tracks and stores in its memory information indicating which slice, if any, was active before the UE went into the Idle or Inactive state and accesses that information when performing the cell reselection process.

In some embodiments, when the UE performs reselection in the case where two cells are available such as cell y (605), which supports slices a and c, and cell z (606), which supports slices b and c, the UE can prioritize cell y over z (608) based on the signal quality of cell y being greater than a signal quality threshold for cell y and the signal quality of cell z being less than a signal quality threshold for cell z.

In some embodiments, the UE performs reselection based, least in part, on battery state information (e.g., battery charge level). For example, in some embodiments, if the battery charge level is less than a battery threshold (e.g., less than 20% of capacity, less than 10% of capacity, etc.), then the UE performs the cell reselection process based on signal conditions and ignores a preference for a slice group and/or S-NSSAI stored preference when selecting the best cell that is available as part of cell reselection process.

### Radio Link Failure (RLF) Recovery Based on Slice Priority Information

The UE may experience RLF for a number of reasons and then need to perform a recovery. The RLF recovery can be due to any of the following: an observed RLF, a Radio Resource Control (RRC) reconfiguration failure, or a handover (HO) failure. For example, a user may be moving in a vehicle and have an RLF and then need to perform a recovery or reestablishment on a different cell.

In some embodiments, to perform RLF recovery, the UE performs reselection and reestablishment based on slice priority information. In some embodiments, the slice priority information can be provided by the network and can be received by the UE via a side channel. In this case, it is assumed that a slice to which the UE is subscribed is available in a current cell and that there is user mobility during slice active on the UE. At this point, to perform the recovery, the UE checks the target cell, RA, or TA that support active slice services and makes its reselection based on the results of checking. That is, as long as the target cell, RA, or TA belongs to the active slice supporting group, then the UE selects the target cell during reselection. In some embodiments, a preference identifying the target can be set at cell, TA, RA or PLMN level.

If the target cell doesn't belong to active slice supporting group and another candidate (or different) cell is available that supports the active slice, then the UE can select the candidate cell supporting the slice if available. In some embodiments, if there are such cells available, then the UE performs the reselection to select one of those cells as long as the cell's signal quality is above a predefined threshold and if there were no previous failures with active slice on that target cell. The failure criteria is important because there may be some cells or tracking areas that are not completely optimized and the user may have had a bad experience in the past, which should be avoided. Thus, if the signal quality threshold is met and no failures have occurred, then the UE selects this different, candidate cell and resumes service with the active slice.

In case that there is no cell supporting that active slice that is available on the current frequency, then the UE checks if there is another frequency that can be selected for resumption of active slice services. In some embodiments, whether the UE can select the other frequency is dependent upon a combination of network configured policies, SIB information and UE stored information. For example, in the case of both frequency range 1 (FR1) and frequency range 2 (FR2), if FR2 doesn't support a certain slice (or no cell available for a certain slice), then the UE can move to a different frequency. In some embodiments, this can occur if performance is better, even if there is a degradation in terms of latency (yet still better than the threshold). The stored information can comprise pattern information (e.g., the UE moves between specified locations during certain days of the week at specific times) and all the cells available (e.g., the UE moves back and forth between a user's home and office and all the cells available and preferred slices/slice groups along that route). Other UE stored information can include an amount of users a particular slice has.

In case there is no cell available supporting active cell, then the UE selects the best cell that is available and initiates a Registration Update to get services in the mapped slice in the target cell. In other words, if there is no cell available supporting active slice, then the UE uses a legacy registration update procedure to get services for the slice. For example, if moving between states and there is a failure at some point and the target cell does not support the previous slices, then the UE performs a registration update to see if the network has any alternative slice to which the UE can be mapped.

In some embodiments, the cell consideration for reselection can be a cell, an RNA, a TA or a RA.

In some embodiments, the UE checks the target cell, TA, or RA check based on a policy provisioned by 5GC or stored information in UE. In some embodiments, the policy can be defined on target cell, TA, or RA singularly or for combinations of two or more of the target cell, TA, and RA.

In some embodiments, in case slice is dormant for some duration (e.g., a few milliseconds, a minute, etc.) and the user is not using services, the UE ignores priority when performing reselection. For example, if the slice has been dormant for a period of time (e.g., the screen is off even though the UE was using an application with this particular slice, the policy can be ignored and a selection based on getting better services is performed). Other indicators that the UE is dormant can be dimming or switching off the screen.

In some embodiments, the UE performs the reselection based on a battery charge level of the UE. For example, in some embodiments, if the battery charge level of the UE's battery is less than a battery charge threshold (e.g., battery charge level at 20% capacity, battery charge level at 10% capacity, etc.), then in a manner similar to that described above, the UE ignores the slice group and/or S-NSSAI stored preference stored preference when selecting the best cell that is available.

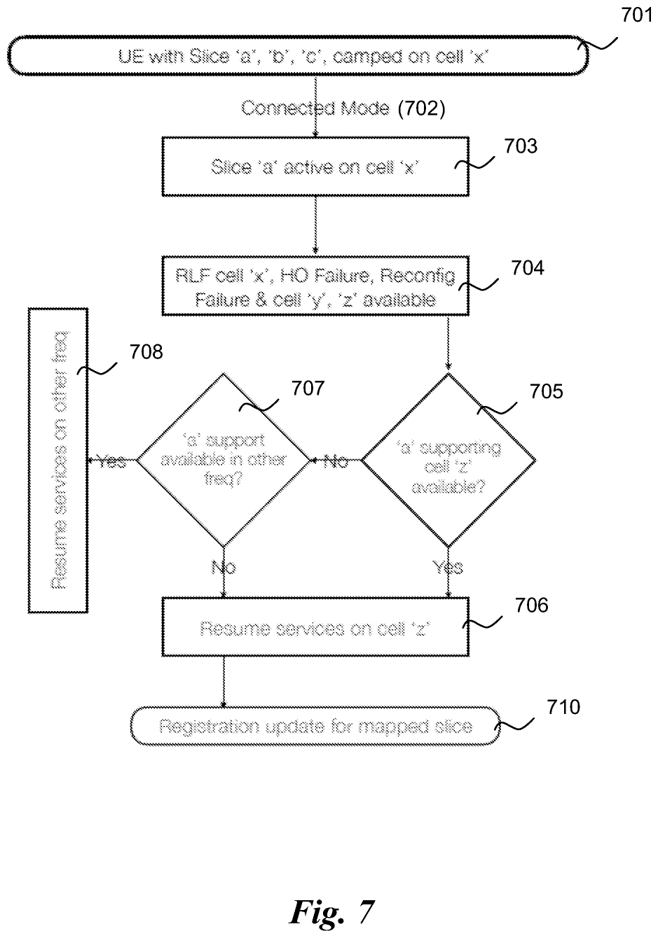

FIG. 7 illustrates an example of UE reselection and reestablishment after RLF based on slice information. Referring to FIG. 7, in this case, the UE is subscribed with slices ‘a’, ‘b’, and ‘c’ and is camped on cell ‘x’ (701), the UE is in Connected mode (702), and slice ‘a’ is active on cell ‘x’ and the user is in mobility while using the services (703). For example, the user of the UE may be watching Apple TV while in their current commute. If the slice is active and the user is using services, then the UE uses the priority information. In the case that slice ‘a’ is dormant and user is not using services, then the UE ignores the priority when performing cell reselection. For example, if the user is using an application, priority is ignored when performing cell reselection based upon whether the screen of the UE is on/off and the application is in the foreground of the display of the UE. If the screen is on and the application is in the foreground, then that slice is given priority and the UE uses that priority when perform reselection; however, if the screen is off or the application is in the background, then the UE uses other priority information (e.g., network priority information) when perform reselection.

In some embodiments, if an RLF is observed, a RRC Reconfiguration failure occurs, or an HO failure occurs, then RLF recovery is required and the UE has to try to recover services on the slice to which it is subscribed. If that slice belongs to a different cell, RA, or TA, then the UE applies a network policy to decide which cell to select. That is, the UE uses a network policy to select a different cell if that cell supports the slice that was active on the cell the UE was using when the failure occurred. This can be required because there may be signaling involved that must be performed to make the change occur. Therefore, the UE checks the policies.

If the cell being considered by the UE is not part of the target cell supporting in the services of the active slice being used by the UE when the failure occurred, then other cells can be selected that belong to the supporting group for that slice. For example, if an RLF is observed, a RRC Reconfiguration Failure occurs, or an HO Failure occurs on cell ‘x’ and cells “y’ and ‘z’ are available (704), then the UE will try to recover services on cell ‘y’. Specifically, the UE checks if cell ‘y’ belongs to target cell, RA, or TA supporting slice ‘a’ services. In some embodiments, this check can be based on a policy provisioned by 5GC or stored information from previous services on cell ‘y’. In case cell ‘y’ doesn't belong to the slice supporting group for slice ‘a’, then the UE determines whether cell ‘z’, which is supporting slice ‘a’, is available and can be selected (705). If so, then the UE selects cell ‘z’ and resumes service on cell ‘z’ for slice ‘a’ (706). In case that there is no cell supporting slice ‘a’ available on the current frequency, then the UE checks if the slice ‘a’ services are available in another frequency that can be selected for resumption of slice ‘a’ services (706,) and if so, resumes slice ‘a’ services on the other frequency (708). In other words, the UE checks if other frequencies can be selected for the resumption of slice ‘a’ services. In some embodiments, the check determines whether the frequency is barred by the network provision policies and whether the user selection would not hamper any of the services the user is using. If slice ‘a’ services are not available in another frequency, then the UE resumes services on cell ‘z’ (706).

In no cell supporting slice ‘a’ services is available, then the UE selects a cell and initiates a Registration Update to get services in the mapped slice in the target cell (710). This may be done using thresholds and priorities as described above.

### IRAT Reselection—Reselecting 5G Based on Network Slice Access Group (NSAG)

In some embodiments, LTE 2 NR (L2NR) reselection is based on stored group information. In some embodiments, the slice group information is provided by the network and the UE uses this information to perform reselection. The slice group information can include network slice access group information such as, for example, group priority information. Such information can include user information such as, for example, the amount of time a slice is used, how often the slice is used, how often the slice is used in a particular location, the time of day

In some embodiments, the UE performs reselection using a preference to select NR cells. In some embodiments, the reselection can be with stored information based on historic support of these slice and uses that information to select cells with better signal quality (e.g., signal quality above a threshold), while avoiding those cells that are not supporting slices with a signal quality greater than the threshold. In some embodiments, the UE prioritizes a cell that previously supported the active slice. For example, if the UE is actively using a slice when the user of the UE is watching Apple TV and a call occurs, when the call ends, then the UE performs reselection by taking into account a priority for the previously supported active slice that was being used when watching Apple TV.

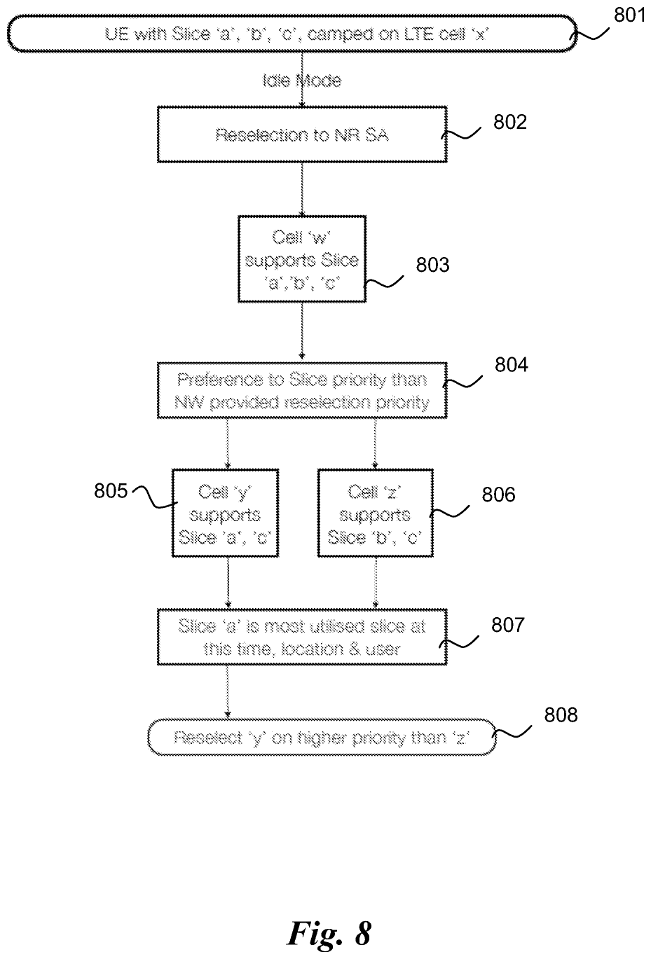

FIG. 8 illustrates an example of performing the reselection of 5G based on the NSAG. Referring to FIG. 8, the UE is camped on LTE cell ‘x’ and supports slice ‘a’, ‘b’, and ‘c’ in New Radio (NR) 5G Standalone (SA) (801). In some embodiments, assuming the network provided slice access group information is previously stored in overlapping coverage of slices ‘a’, ‘b’, and ‘c’ for the UE, and the UE utilized mostly slice ‘a’ during this time of day near this location and PLMN. Then, in this case, in some embodiments, when performing the reselection, the UE considers the UE based S-NSSAI priority. Thus, the UE can select slice ‘a’ because slice “a’ is the most utilized slice at this time and location for this user (807).

When performing Idle mode reselection from LTE to NR (802), in some embodiments, the UE prefer NR cells with stored information on priority of historic slice support in the cell, TA, or RA. In some embodiments, when cell ‘w’ supports slices ‘a’, ‘b’, and ‘c’, the UE performs reselection using preferences based on slice priority over the NW provided reselection priority (804). For example, in some embodiments, when performing reselection, the UE selects cell ‘w’ if its signal quality is less than a threshold associated with cell ‘w’ and selects other cells not supporting slices ‘a’, ‘b’, and ‘c’ if the signal quality is greater than a threshold associated with cell ‘x’. Thus, in some embodiments, the UE avoids performing reselection based on network (NW) provided slice group preferences and also ignores the S-NSSAI preference as a subset of the NW provided slice group.

In case cells are available supporting priority slices based on user utility stored information. In some embodiments, the preference of cells based on the information available. For example, if cell ‘y’ supports slices ‘a’ and ‘c’ (806) and cell ‘z’ supports slices ‘b’ and ‘c’ (806), the UE can select slice “a’ because it's the most used slice at the time and location for the user (807) and can reselect cell ‘y’ because its priority is higher than that of cell ‘z’ (808).

In some embodiments, the reselection is based on the battery charge level of the UE. For example, in some embodiments, fi the battery charge level of the battery in the UE is less than a threshold B, then the UE ignores the slice group and S-NSSAI stored preferences and selects the best cell available.

Note that in some embodiments, ‘x’, ‘y’, ‘z’, and ‘w’ can be cells, RNA, TA or RA, based on preference provided by the network and stored in UE.

### Ping Pong Avoidance

In some embodiments, the UE avoids going back and forth between the reselection of cells and handovers. This could occur in a number of situations. For example, this can occur when with higher priority as per UE calculated priority and user behavior priority while in case B with base station pushed handover are available. For example, if the UE has a priority for a particular slice and the network forces a handover to a different cell, when the UE performs reselection, the UE may want to select the previous cell that they exited due to the forced handover. In such cases, the UE may go back and forth between cells, RNA or TA, where A can be cell, RNA or TA.

To do so, there are a number of operations that can be performed. For example, in some embodiments, the UE can limit the use of localized preferences and follow network provided preferences in case of user inactivity. In some embodiments, if the NW provided slice access group preference and/or UE calculated S-NSSAI preference cause performance degradation, then the UE can prefer a signal threshold based reselection and reestablishment and ignore the UE calculated and NW provided slice access group preferences when performing reselection. In some embodiments, if the above preference causes higher battery consumption and user is not utilizing the slice for duration T, then the UE can ignore S-NSSAI/Slice access group based reselection and recovery process when performing reselection.

### Exemplary Flows

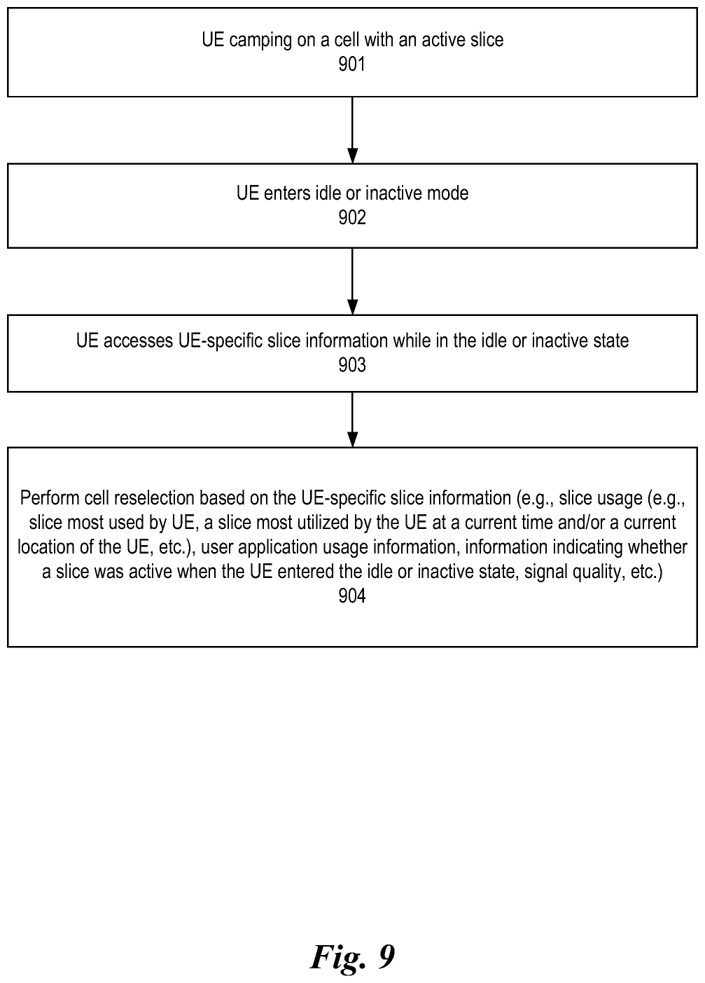

FIG. 9 illustrates a data flow diagram of one embodiment for process for performing UE reselection based on slice information. The process is performed by processing logic that comprises hardware (circuitry, dedicated logic, etc.), software (e.g., software running on a chip, software run on a general-purpose computer system or a dedicated machine, etc.), firmware, or a combination of the three. In one embodiment, the operations in the process are performed by a UE in a 5G NR communication system. In some embodiments, the process is performed by a UE in a 5G NR communication system comprising a processor (or processing circuitry) and/or a baseband processor in a 5G NR communication system configured to perform the following operations.

Referring to FIG. 9, the process begins with the UE camping on a cell with an active slice (processing block 901) and then entering in idle or inactive mode (processing block 902).

After entering the idle or inactive mode, the UE subsequently accesses UE-specific slice information (processing block 903). In one embodiment, the UE slice information comprises information indicative of slice usage representing the UE's usage of one or more slices. In some embodiments, the slice usage information indicates the slice most utilized by the UE. In some embodiments, the slice usage information indicates the slice most utilized by the UE at a current time and/or a current location of the UE.

In some embodiments, the UE-specific slice information comprises user application usage information corresponding to the applications used by the UE. In some embodiments, the user application usage information provides information indicating whether a slice was active or on standby when the UE entered the idle or inactive state. In some embodiments, the user application usage information comprises user application usage preferences. In some embodiments, these preferences are configured by a user via a user interface or a user-initiated service invoking application usage prior to entering the idle or inactive state. In some embodiments, the user application usage information comprises preference information indicating a preference to select a cell supporting a slice within which the user launches an application while in the idle or inactive state. In other words, when performing reselection, the preference would be to select a cell that supports a slice in which an application executes where the user launched the application while in the idle or inactive mode.

After accessing the UE-specific slice information while in the idle or inactive state, processing logic performs cell reselection based on the UE-specific slice information (processing block 904). In some embodiments, the processing logic can perform the cell reselection with or without the network provided slice supporting information. In some embodiments, performing the cell reselection comprising ignoring slice group and/or S-NASSAI stored preference information. In some embodiments, this information is ignored when the battery capacity for a battery of the UE is less than the threshold amount (e.g., under 10% capacity, under 20% capacity, etc.).

In some embodiments, the process further comprises obtaining at least one signal quality measurement, and performing reselection is based on whether the signal quality measurements. For example, if another cell is available with the same set of slices but is a lower priority cell (according to the network) in comparison to other available cells, this cell can still be selected in some embodiments if its signal quality is greater than a threshold associated with the cell and the signal quality of other available cells is less than the signal quality threshold associated with the last cell upon which the UE was previously camped.

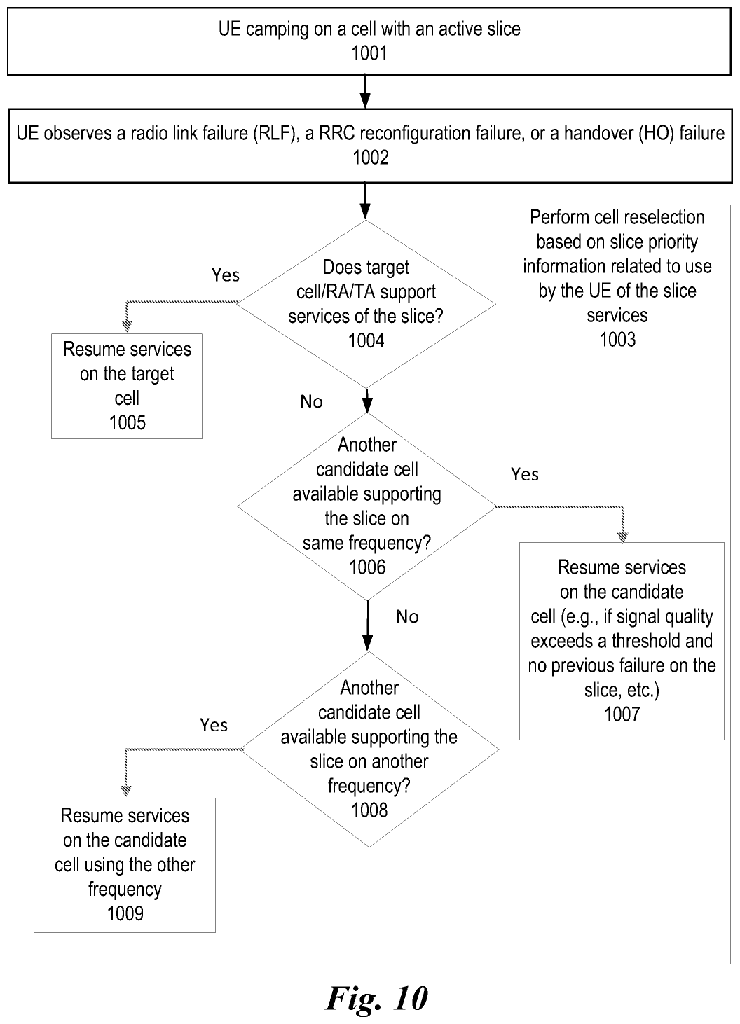

FIG. 10 is a data flow diagram of some embodiments of a process for performing radio link failure recovery based on slice priority information. The process is performed by processing logic that comprises hardware (circuitry, dedicated logic, etc.), software (e.g., software running on a chip, software run on a general-purpose computer system or a dedicated machine, etc.), firmware, or a combination of the three. In one embodiment, the operations in the process are performed by a UE in a 5G NR communication system. In some embodiments, the process is performed by a UE in a 5G NR communication system comprising a processor (or processing circuitry) and/or a baseband processor in a 5G NR communication system configured to perform the following operations.

Referring to FIG. 10, the process begins by the UE camping on a cell with an active slice (processing block 1001) and the UE observing a radio link failure (RLF), a RRC reconfiguration failure, or a handover (HO) failure (processing block 1002). In response to observing the RLF failure, the RRC reconfiguration failure or the HO failure, processing logic performs cell selection based on slice priority information related to use by the UE of the slice services (processing block 1003). In one embodiment, the slice priority information provides information indicative of whether a subscribed slice is available in a cell and the UE is using services of the slice when the occurrence of the failure occurred or was observed. In some embodiments, performing cell selection comprises ignoring slice group and S-NASSAI stored preference information. In some embodiments, performing cell selection occurs while ignoring the slice priority information if the slice has been dormant for a predetermined period of time and the services are not being used by the UE. In some embodiments, this information is ignored when the battery capacity for the battery of the UE is less than a threshold (e.g., less than 10% battery capacity, less than 20% battery capacity, etc.).

In some embodiments, performing cell selection comprises determining whether another cell belongs to a group supporting the slice based on the slice priority information where this cell is different from the current cell and resuming services with the slice on the second cell if the second cell is determined to belong to a slice group supporting the slice. In some embodiments, the services are resumed based on the signal quality of the second cell exceeding a threshold and if there are no previous failures with the slice on the second cell. In some embodiments, the determination of whether the second cell belongs to a group supporting the slices is based on a policy provision by the network and/or historic information from previous services on the second cell.

In some embodiments, performing cell selection comprises determining whether any cell selectable for selection belongs to a group supporting the slice on a first frequency and determining whether a second cell belongs to a group supporting the slice on a second frequency different from the first frequency. In some embodiments, this determination occurs in response to determining that no cell is selectable for selection belonging to a group supporting the slice on the first frequency. If processing logic determines that a second cell belongs to a group supporting the slice on a second frequency different than the first frequency, processing logic of the UE resumes the services with the slice on the second cell at the second frequency if the second cell is determined to belong to the group supporting the slice on the second frequency. In some embodiments, the second frequency is selected based on system information block (SIB) information, network specified (e.g., configured, provided, etc.) neighbor information, and UE stored information.

In some embodiments, performing cell selection comprises processing logic determining whether the target cell/RA/TA supports the services of the slice that was active while the UE was camping on the cell (processing block 1004). If that is the case, processing logic transitions to processing block 1005 where the UE resumes services on the target cell. If the target cell does not support the services of the slice, processing logic determines whether another candidate cell is available supporting the slice on the same frequency (processing block 1006). If so, the process transitions to processing block 1007 where the UE resumes services on the candidate cell. In some embodiments, the UE resumes services on the candidate cell if the signal quality of the cell exceeds a threshold associated with the cell and there are no previous failures on the slice with that cell.

If another candidate cell is not available supporting the slice of the same frequency, processing logic determines whether another candidate cell is available supporting the slice on another frequency (processing block 1008). If so, processing logic resumes services on the candidate cell using the other frequency (processing block 1009).

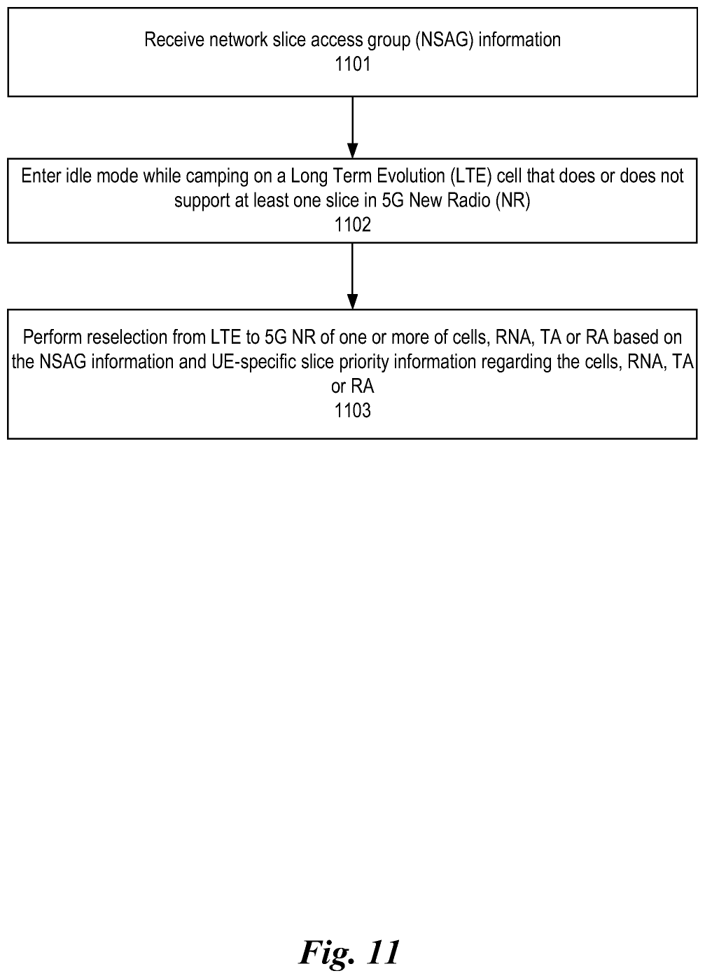

FIG. 11 is a data flow diagram of one embodiment of a process for performing IRAT reselection. The process is performed by processing logic that comprises hardware (circuitry, dedicated logic, etc.), software (e.g., software running on a chip, software run on a general-purpose computer system or a dedicated machine, etc.), firmware, or a combination of the three. In one embodiment, the operations in the process are performed by a UE in a 5G NR communication system. In some embodiments, the process is performed by a UE in a 5G NR communication system comprising a processor (or processing circuitry) and/or a baseband processor in a 5G NR communication system configured to perform the following operations.

Referring to FIG. 11, the process begins by receiving network slice access group (NSAG) information (processing block 1101). Thereafter, processing logic enters the idle mode while camping on a long term evolution (LTE) cell that does or does not support at least one slice in 5G new radio (NR) (processing block 1102). Subsequent to entering idle move, processing logic performs reselection from LTE to 5G NR of one or more of the cells, RNA, TA or RA based on the NSAG information and UE-specific slice priority information regarding the cells, RNA, TA or RA (processing block 1103). In some embodiments, the UE-specific slice priority information includes information indicating slice usage during a particular time of day by the UE and/or UE location, and performing reselection (or redirection) is made to a cell supporting the slice while ignoring the NSAG information if contrary to slice priority or using NSAG information otherwise. In some embodiments, the slice usage information includes information indicating the slice most used by the UE during a current time of day and a current location of the UE.

There are a number of example embodiments described herein.

Example 1 is a method comprising accessing UE-specific slice information while in the idle or inactive state; and performing cell reselection based on the UE slice information associated with individual slices.

Example 2 is the method of example 1 that may optionally include that UE slice information comprises information indicative of slice usage representing UE usage of one or more slices.

Example 2 is the method of example 2 that may optionally include that the slice usage information indicates a slice most utilized by the UE.

Example 4 is the method of example 3 that may optionally include that the slice usage information indicates a slice most utilized by the UE at a current time or a current location of the UE.

Example 5 is the method of example 1 that may optionally include that the UE-specific slice information comprises user application usage information of the UE.

Example 6 is the method of example 5 that may optionally include that the user application usage information comprises information indicating whether a slice was active or on standby when the UE entered the idle or inactive state.

Example 7 is the method of example 5 that may optionally include that the user application usage information comprises user application usage preferences configured by a user via a user interface or a user-initiated service invoking application usage.

Example 8 is the method of example 5 that may optionally include that the user application usage information comprises preference information indicating a preference to select a cell supporting a slice within which the user launches an application while in an idle or inactive state.

Example 9 is the method of example 1 that may optionally include obtaining at least one signal quality measurement, and wherein performing cell reselection comprises performing reselection to a cell with a first signal quality that is greater than a first threshold and a second signal quality of a second cell being less than a second threshold.

Example 10 is the method of example 1 that may optionally include that performing cell reselection comprises ignoring slice group and S-NASSAI stored preference information when battery capacity for a battery of the UE is less than a threshold.

Example 11 is a user equipment (UE) comprising one or more processors configured to perform one or more of the operations of examples 1-10.

Example 12 is a baseband processor comprising one or more processors configured to perform one or more of the operations of examples 1-10.

Example 13 is a method comprising: observing occurrence of at least one of a radio link failure (RLF), a Radio Resource Control (RRC) reconfiguration failure, and a handover (HO) failure while the UE is subscribed to a slice in a current cell and using services of the slice; and performing cell selection based on slice priority information related to use by the UE of the services of the slice.

Example 14 is the method of example 13 that may optionally include that the slice priority information comprises information indicative of whether a subscribed slice is available in a current cell and the UE is using services of the slice when the occurrence of the at least one of a RLF, an RRC reconfiguration failure, and a HO failure was observed.

Example 15 is the method of example 13 that may optionally include that performing cell selection comprises: determining whether a second cell belongs to a group supporting the slice based one the slice priority information, the second cell different from the current cell; and resuming the services with the slice on the second cell if the second cell is determined to belong to a slice group supporting the slice based on signal quality exceeding a threshold and if no previous failure with the slice on the second cell.

Example 16 is the method of example 15 that may optionally include that determining whether the second cell belongs to a group supporting the slice is based on a policy provisioned by a network or stored information from previous services on the second cell.

Example 17 is the method of example 15 that may optionally include that performing cell selection comprises: determining whether any cell selectable for selection belongs to a group supporting the slice on a first frequency; determining that a second cell belongs to a group supporting the slice on a second frequency different than the first frequency in response to determining no cell is selectable for selection belongs to a group supporting the slice on a first frequency; and resuming the services with the slice on the second cell at the second frequency if the second cell is determined to belong to group supporting the slice on the second frequency.

Example 18 is the method of example 17 that may optionally include that the second frequency is selected based on system information block (SIB) information, network specified neighbor information and UE stored information.

Example 19 is the method of example 13 that may optionally include that performing cell selection comprises ignoring slice group and S-NASSAI stored preference information when battery capacity for a battery of the UE is less than a threshold.

Example 20 is the method of example 13 that may optionally include performing cell selection while ignoring the slice priority information if the slice has been dormant for a predetermined period of time and the services are not being used by the UE.

Example 21 is a user equipment (UE) comprising one or more processors configured to perform one or more of the operations of examples 13-20.

Example 22 is a baseband processor comprising one or more processors configured to perform one or more of the operations of examples 13-20.

Example 23 is a method comprising: receiving network slice access group (NSAG) information; entering idle mode while camping on a Long Term Evolution (LTE) cell that does or does not supports at least one slice in 5G New Radio (NR); and performing reselection from LTE to 5G NR of one or more of a cell, RNA, TA or RA based on the NSAG information and UE-specific slice priority information regarding the one or more of a cell, RNA, TA or RA.

Example 24 is the method of example 23 that may optionally include that the UE-specific slice priority information indicates slice usage during time of day and UE location, and performing reselection or redirection from LTE to 5G NR of one or more of cells, RNA, TA or RA is made to a cell supporting the slice while ignoring the NSAG information if contradictory to slice priority or else supporting NSAG information, and that the slice usage comprises information indicating the slice most used by the UE during a current time of day and a current location of the UE and based on subscription information available.

Example 25 is a user equipment (UE) comprising one or more processors configured to perform one or more of the operations of examples 23-24.

Example 26 is a baseband processor comprising one or more processors configured to perform one or more of the operations of examples 23-24.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A user equipment (UE) comprising one or more processors configured to perform operations comprising:
accessing UE-specific slice information while in the idle or inactive state; and
performing cell reselection based on the UE slice information associated with individual slices.

2. The UE of claim 1 wherein UE slice information comprises information indicative of slice usage representing UE usage of one or more slices.

3. The UE of claim 2 wherein the slice usage information indicates a slice most utilized by the UE.

4. The UE of claim 3 wherein the slice usage information indicates a slice most utilized by the UE at a current time or a current location of the UE.

5. The UE of claim 1 wherein the UE-specific slice information comprises user application usage information of the UE.

6. The UE of claim 5 wherein the user application usage information comprises information indicating whether a slice was active or on standby when the UE entered the idle or inactive state.

7. The UE of claim 5 wherein the user application usage information comprises user application usage preferences configured by a user via a user interface or a user-initiated service invoking application usage.

8. The UE of claim 5 wherein the user application usage information comprises preference information indicating a preference to select a cell supporting a slice within which the user launches an application while in an idle or inactive state.

9. The UE of claim 1 further comprising obtaining at least one signal quality measurement, and wherein performing cell reselection comprises performing reselection to a cell with a first signal quality that is greater than a first threshold and a second signal quality of a second cell being less than a second threshold.

10. The UE of claim 1 wherein performing cell reselection comprises ignoring slice group and S-NASSAI stored preference information when battery capacity for a battery of the UE is less than a threshold.

11. A user equipment (UE) comprising one or more processors configured to perform operations comprising:
observing occurrence of at least one of a radio link failure (RLF), a Radio Resource Control (RRC) reconfiguration failure, and a handover (HO) failure while the UE is subscribed to a slice in a current cell and using services of the slice; and
performing cell selection based on slice priority information related to use by the UE of the services of the slice.

12. The UE of claim 11 wherein the slice priority information comprises information indicative of whether a subscribed slice is available in a current cell and the UE is using services of the slice when the occurrence of the at least one of a RLF, an RRC reconfiguration failure, and a HO failure was observed.

13. The UE of claim 11 wherein performing cell selection comprises:
determining whether a second cell belongs to a group supporting the slice based one the slice priority information, the second cell different from the current cell; and
resuming the services with the slice on the second cell if the second cell is determined to belong to a slice group supporting the slice based on signal quality exceeding a threshold and if no previous failure with the slice on the second cell.

14. The UE of claim 13 wherein determining whether the second cell belongs to a group supporting the slice is based on a policy provisioned by a network or stored information from previous services on the second cell.

15. The UE of claim 11 wherein performing cell selection comprises:
determining whether any cell selectable for selection belongs to a group supporting the slice on a first frequency;
determining that a second cell belongs to a group supporting the slice on a second frequency different than the first frequency in response to determining no cell is selectable for selection belongs to a group supporting the slice on a first frequency; and
resuming the services with the slice on the second cell at the second frequency if the second cell is determined to belong to group supporting the slice on the second frequency.

16. The UE of claim 15 wherein the second frequency is selected based on system information block (SIB) information, network specified neighbor information and UE stored information.

17. The UE of claim 11 wherein performing cell selection comprises ignoring slice group and S-NASSAI stored preference information when battery capacity for a battery of the UE is less than a threshold.

18. The UE of claim 11 further comprising performing cell selection while ignoring the slice priority information if the slice has been dormant for a predetermined period of time and the services are not being used by the UE.

19. A user equipment (UE) comprising one or more processors configured to perform operations comprising:
receiving network slice access group (NSAG) information;
entering idle mode while camping on a Long Term Evolution (LTE) cell that does or does not supports at least one slice in 5G New Radio (NR); and
performing reselection from LTE to 5G NR of one or more of a cell, RNA, TA or RA based on the NSAG information and UE-specific slice priority information regarding the one or more of a cell, RNA, TA or RA.

20. The UE of claim 19 wherein the UE-specific slice priority information indicates slice usage during time of day and UE location, and performing reselection or redirection from LTE to 5G NR of one or more of cells, RNA, TA or RA is made to a cell supporting the slice while ignoring the NSAG information if contradictory to slice priority or else supporting NSAG information, and wherein the slice usage comprises information indicating the slice most used by the UE during a current time of day and a current location of the UE and based on subscription information available.
